(19) United States
(12) Patent Application Publication
(10) Pub. No.: US 2026/0106923 A1
(43) Pub. Date: Apr. 16, 2026

(54) FLOW CHANNEL HASH FUNCTION

(71) Applicant: Hewlett Packard Enterprise Development LP, Spring, TX (US)

(72) Inventors: Jonathan P. Beecroft, Bristol (GB); Trevor Alan Jones, Bridgwater (GB); Joseph Orth, Longmont, CO (US)

(21) Appl. No.: 18/913,856

(22) Filed: Oct. 11, 2024

(51) Int. Cl. H04L 69/22

(52) U.S. Cl. CPC H04L 69/22

(57) ABSTRACT

One aspect of the instant application provides a network node. The network node may include a packet-header parser to extract a plurality of header fields from a received packet, a hash logic unit to compute a hash value based on the plurality of extracted header fields, and a flow-identifying logic unit to associate the packet with a flow identifier (ID) based on the computed hash value. The flow ID facilitates subsequent network nodes along a path to the packet's destination to recognize the packet as belonging to a flow.

### STATEMENT OF GOVERNMENT-FUNDED RESEARCH

This invention was made with Government support under Contract Number H98230-15-D-0022/0003 awarded by the Maryland Procurement Office. The Government has certain rights in this invention.

### BACKGROUND

### Field

This disclosure is generally related to implementing flow-channel-based congestion control in networks. More specifically, this disclosure is related to identifying and separating packet flows.

### Related Art

Flow channels have been used to separate data packets sent to different destinations while keeping data packets sent to the same destination together and in order. The establishment of flow channels makes it possible to track the data path of packet flows, the amount of transmitted data, acknowledgments returned upon successful delivery of packets, and congestion detected along the way, thus providing fast and effective congestion control.

### BRIEF DESCRIPTION OF THE FIGURES

FIG. 1 illustrates an example network environment, according to one aspect of the instant application.

FIG. 2 illustrates the architecture of an example network node, according to one aspect of the instant application.

FIG. 3 illustrates the block diagram of an example hash-generation function, according to one aspect of the instant application.

FIG. 4 presents a flowchart illustrating an example process for identifying packets belonging to different flow channels, according to one aspect of the instant application.

FIG. 5 illustrates an example block diagram of a network device, according to one aspect of the instant application.

FIG. 6 illustrates a computer-readable medium that facilitates the separation of packet flows, according to one aspect of the instant application.

In the figures, like reference numerals refer to the same figure elements.

### DETAILED DESCRIPTION

Existing approaches to network flow management typically implement flow channels within a single switching fabric, where all devices are governed by a unified set of policies. In this model, flow channels are created at the fabric's ingress, traverse a specific path through the fabric, and terminate at the egress point. When flow channels are confined by the fabric boundary, so is the flow-channel based congestion control. As data traverses from one fabric to another, the flow information and congestion information associated with each flow may not be consistently recognized. It is challenging to apply flow-channel-based end-to-end congestion management across multiple independently managed networks.

According to some aspects of the instant application, data packets injected into a network may be categorized into “packet flows” (or “flows”) based on their destination. A packet flow may use a plurality of flow channels, one taken per link and sequentially connected to form a continuous flow path. Flow-channel-based congestion control allows each node (e.g., a switch or router) along the data path to monitor and manage the level of congestion of individual flows, thus facilitating fast and effective congestion control and allowing the network to operate at a higher capacity.

In a fabric implementing flow-channel-based congestion control, each flow may be marked by a distinctive identifier (also known as the flow ID). For example, the ingress switch of a fabric may assign a flow ID to packets belonging to the same flow.

This flow ID may be a locally significant value specific to a link, and this value may be unique only to a particular input port on a node. When the packets are forwarded to the next-hop node, the packets enter another link, and the flow ID may be updated accordingly. More specifically, each link, in each direction, may have one set of flow channels identified by their respective flow IDs. As the packets of a flow traverse multiple links and nodes, the flow IDs corresponding to this flow can form a unique chain. At every node, the flow ID of an incoming packet may be used to map an entry in an input flow-channel table (IFCT), which stores state information for the corresponding flow. The outgoing packet may be updated to a flow ID used by the outgoing link, and the mapping between the incoming flow ID and the outgoing flow ID may be stored in an output flow-channel table (OFCT). This up-stream-to-down-stream one-to-one mapping between flow IDs can begin at the ingress edge node and end at the egress edge node. Because the flow IDs only need to be unique within an incoming link, a node may accommodate a large number of flows.

Flow channels may be set up and released dynamically, or “on the fly,” based on demand. Specifically, a flow channel is established (e.g., the flow ID to packet header mapping is established) at the ingress node when an initial packet of a flow arrives, and no flow ID has been previously assigned to the flow. As this initial packet travels through the network, flow IDs can be assigned at every node along the path traversed by the packet, and a chain of flow IDs (i.e., the sequentially connected flow channels) is established from the ingress node to the egress node. Subsequent packets belonging to the same flow use the same chains of flow IDs along the data path. When packets are delivered to the destination egress node, the egress node may generate and send an acknowledgment (ACK) packet in the upstream direction along the same data path to the ingress node. After receiving the ACK packets, each node along the data path may update its state information with respect to the amount of outstanding, unacknowledged data for this flow. When a node's input queue for a flow is empty, and there is no more unacknowledged data, the node may release the flow ID (i.e., release this flow channel) and re-use the flow ID for other flows.

In existing approaches, flow channels are typically bounded by a single fabric, and flow IDs may be mapped to the packets'fabric destination addresses. More specifically, when a packet is received, address translation is performed to convert an external Media Access Control (MAC) or Internet Protocol (IP) address in the packet header to the internal fabric address. In situations where multiple independently managed systems are deployed at a single site (e.g., a supercomputer system and a storage system at a weather forecasting site), each system may have its own fabric and header translation requirement, and the ingress node in the ingress fabric may not have knowledge of the fabric address of the egress node in the egress fabric. To facilitate end-to-end flow channel-based congestion management across multiple fabrics, according to some aspects of the instant application, the flow IDs may be generated without the need to perform any header translation. More specifically, a single large hash value based on a plurality of header fields in the packet may be computed and used to distinguish flows. In some aspects, the hash value is computed based on all header fields of an incoming packet to ensure a sufficiently large entropy such that the flow separation will be sufficient, no matter how may fabrics the flow traverses.

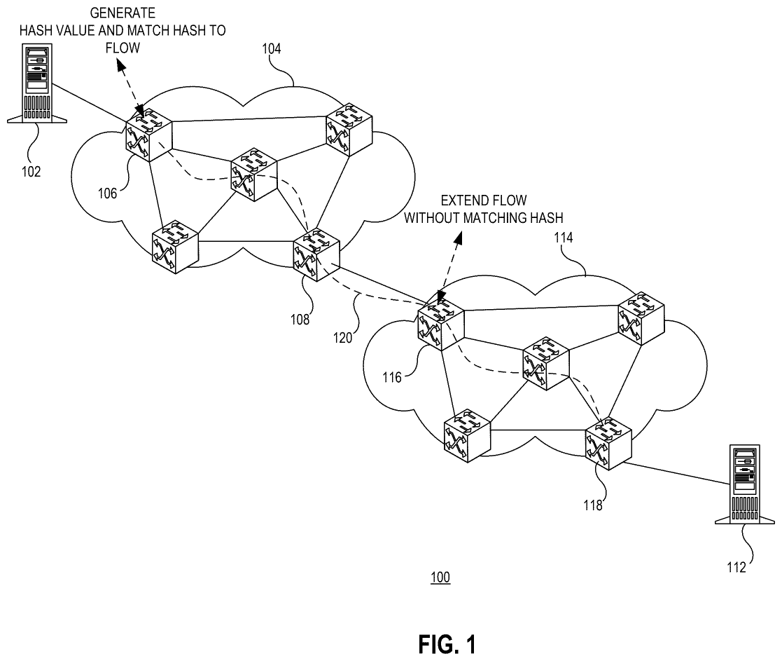

FIG. 1 illustrates an example network environment, according to one aspect of the instant application. In FIG. 1, a network environment 100 may include two independently managed systems. The first system may include a server 102 and a switch fabric 104, and the second system may include a server 112 and a switch fabric 114. Each switch fabric may include a plurality of interconnected switches. For example, switch fabric 104 includes switches 106 and 108, and switch fabric 114 includes switches 116 and 118.

FIG. 1 also shows the path of a flow 120 established between servers 102 and 104, indicated by a dashed line. As discussed previously, when the initial packet belonging to flow 120 is injected into ingress switch 106 of fabric 104, ingress switch 106 may assign a flow ID (i.e., allocate a new flow channel) to the packet, the flow ID being unique to the input port receiving the packet. According to some aspects, when assigning the flow ID, ingress switch 106 may generate a large hash value based on a plurality of predetermined header fields in the injected packet. The header fields used for the hash generation may include but are not limited to source address, source port, destination address, destination port, traffic class, differentiated services code point (DSCP), flow label, Virtual Extensible Local Area Network (VXLAN) Network Identifier (VNI), entropy field in Ultra Ethernet Consortium (UEC) standard, metadata used for packet snooping, etc. Additional examples may include the Ethernet layer 2 (L2) header, the Internet protocol (IP) version 4 (IPv4) or IPv6 layer 3 (L3) header, and/or a layer 4 (L4) header, such as a Transmission Control Protocol (TCP) or a User Datagram Protocol (UDP) header. If the packet has been encapsulated for network overlays or other purposes, then the L2, L3, and/or L4 headers of the encapsulated packet may also be included. Any of the fields that are extracted by the packet parser, taken from multiple headers of the layered protocols, may be included in the hash computation. Additional header information, including but not limited to the source port and other meta data that might be included in a subsequent translation lookup, may also help generating the hash value. Entropy values taken from local storage (e.g., the control and status registers) may also be included. According to some aspects, ingress switch 106 may include a packet-header parser. The packet-header parser may be configured by a Control and Status Register (CSR) to extract a subset of header fields from an injected packet for the generation of the hash value. Packet header fields that might change for a given flow (e.g., Explicit Congestion Notification (ECN) field used to indicate congestion or packet sequence number) should preferably not be included in the hash computation, as they may cause packets belonging to a single flow to be separated into multiple flows. Splitting a flow into multiple flows may lead to packets being out of order, which usually is undesirable.

The mapping between the large hash value and the flow ID may be stored in an edge flow-channel table (EFCT). According to some aspects, the EFCT may be stored in a Content Addressable Memory (CAM), such as a TCAM or any other hash-based lookup function suitable for exact match operations. It is also possible to implement any function capable of performing match operations (i.e., any match function), such as an exact match hash function implemented using multiple RAMs or a match function implemented using a plurality of discrete logic gates. In some examples, the flow ID may be 12-bit long, and the large hash value may be at least 40-bit long. Note that there is a tradeoff between the hash size and part cost. A larger hash size can reduce the likelihood of a hash collision but may increase the size of the match function (e.g., the TCAM), thus increasing the part cost.

When subsequent packets with the same destination are injected into ingress switch 106, their header fields may be parsed to generate the same large hash value, which may be used to look up the flow-channel table (i.e., the EFCT) to obtain the flow ID. On the other hand, different hash values may be generated for subsequent packets with different destinations and matched to different flow IDs. As a result, packets with different header fields may be separated into different flows based on the hash values.

After the initial packet of flow 120 leaves switch fabric 104 via egress switch 108, the packet enters switch fabric 114 via its ingress switch (i.e., switch 116). Ingress switch 116 of the second fabric does not need to regenerate the hash value as the flow extends from switch fabric 104 into switch fabric 114 using the same hash generated by switch 106. Ingress switch 116 may map the flow ID generated by the egress switch (e.g., switch 108) of the previous fabric to the extended flow. In some examples, ingress switch 116 may perform match and action translation functions based on the hash value to choose the destination for the second fabric. Note that the hash value generated by switch 106 in fabric 104 should still provide the correct flow separation needed for the fabric 114, because all the fields that fabric 114 might use were included in the generation of the hash value at switch 106. In this way the management of the two fabrics has been separated as the management of fabric 104 does not need any knowledge of the connectivity in fabric 114. The ability to separate untranslated packets into flows can facilitate translation caching, where injected packets may be queued in flow-specific queues in the correct order while waiting for translation. Translation caching can expand the available translation capacity space.

In the example shown in FIG. 1, a chain of flow IDs may be established from the ingress switch 106 to the egress switch 118, forming the flow 120 across switch fabrics 104 and 114. After a packet is delivered to its destination (e.g., server 112), the egress switch (e.g., switch 118) may generate and send back an ACK toward ingress switch 106, traversing all switches along flow 120, and each switch along the path may update the state information of the flow based on information included in the ACK (e.g., the amount of acknowledged data).

Each node in FIG. 1 is a computing device, which may be any single computing device, a set of computing devices, a portion of one or more computing devices, or any other physical, virtual, and/or logical grouping of computing resources. According to some aspects, a computing device is any device, portion of a device, or any set of devices capable of electronically processing instructions and may include, but is not limited to, any of the following: one or more processors (e.g., components that include circuitry) (not shown), memory (e.g., random access memory (RAM)) (not shown), input and output device(s) (not shown), non-volatile storage hardware (e.g., solid-state drives (SSDs), persistent memory (Pmem) devices, hard disk drives (HDDs) (not shown)), one or more physical interfaces (e.g., network ports, storage ports) (not shown), any number of other hardware components (not shown), and/or any combination thereof.

Examples of computing devices include, but are not limited to, a server (e.g., a blade-server in a blade-server chassis, a rack server in a rack, etc.), a desktop computer, a mobile device (e.g., laptop computer, smartphone, personal digital assistant, tablet computer, automobile computing system, and/or any other mobile computing device), a storage device (e.g., a disk drive array, a fiber channel storage device, an Internet Small Computer Systems Interface (iSCSI) storage device, a tape storage device, a flash storage array, a network attached storage device, etc.), a network device (e.g., switch, router, multi-layer switch, etc.), a virtual machine, a virtualized computing environment, a logical container (e.g., for one or more applications), an Internet of Things (IoT) device, an array of nodes of computing resources, a supercomputing device, a data center or any portion thereof, and/or any other type of computing device with the aforementioned requirements.

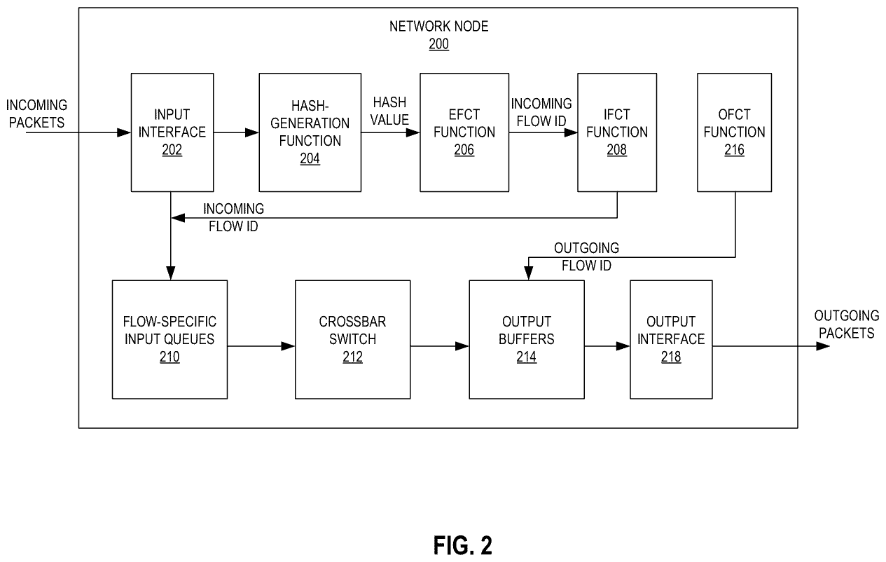

FIG. 2 illustrates the architecture of an example network node, according to one aspect of the instant application. In FIG. 2, a network node 200 may include an input interface 202, a hash-generation function 204, an EFCT function 206, an IFCT function 208, a set of flow-specific queues 210, a crossbar switch 212, a set of output buffers 214, an OFCT function 216, and an output interface 218. In some examples, network node 200 may be an ingress edge switch of a switch fabric. The various components in network node 200 may be implemented using any form of hardware, firmware, software, or a combination thereof.

Input interface 202 is responsible for receiving communication packets from end hosts coupled to network node 200. Depending on the communication protocol, the packets may include various types of headers. In one example, the communication packets may include Ethernet frames. Hash-generation function 204 is responsible for generating a large hash value based on one or more header fields included in the incoming packets, and possibly one or more other values including but not limited to the source port number, additional meta data that may be present and needed for a translation, and an additional entropy value taken from a storage value. According to some aspects, hash-generation function 204 may extract a plurality of predetermined header fields (e.g., source address, source port, destination address, destination port, traffic class, differentiated services code point (DSCP), flow label, Virtual Extensible Local Area Network (VXLAN) Network Identifier (VNI), entropy field in Ultra Ethernet Consortium (UEC) standard, metadata used for snoop (which ensures the separation between original and snooped packets), etc.) from an incoming packet to generate a hash value (e.g., by applying a predetermined hash function). To reduce the likelihood of a hash collision, the generated hash value may be at least 40-bit long. Other hash value widths that may be narrower or wider are also possible.

EFCT function 206 may be responsible for performing a lookup in an EFCT based on the hash value. The EFCT may be implemented using a match function (e.g., a TCAM, an exact match hash function implemented using multiple RAMs, or a match function implemented using a plurality of discrete logic gates) capable of matching an incoming value against a number of stored values, and EFCT function 206 may perform a lookup operation by comparing the hash value generated for an incoming packet to hash values stored in the EFCT. If a match is found, the incoming packet belongs to an existing flow, and a flow ID previously allocated to the flow may be returned and associated with the incoming packet. In one example, the returned flow ID may be attached (e.g., as an additional header field) to the incoming packet. If no match is found, a new flow may be created by allocating a new flow ID and adding the mapping between the hash value and the new flow ID to the EFCT.

IFCT function 208 is responsible for storing state information for the various flows using the flow IDs as indices. For example, an entry in the IFCT may include a data_flow field that indicates the progress of the flow. The IFCT may further store various flow-control parameters. Flow-specific input queues 210 may be used to temporarily store incoming packets. The flow ID associated with a packet may be used to identify and allocate a flow-specific input queue. The implementation of the flow-specific input queues allows each flow to move independently of all other flows.

Crossbar switch 212 is responsible for forwarding packets from flow-specific input queues 210 to output buffers 214.

OFCT function 216 may store the mapping between the incoming flow IDs and the outgoing flow IDs. When the packet reaches an output buffer, OFCT function 216 may perform a lookup operation based on the incoming flow ID and the input port number. If a match is found, a flow channel has been previously defined on network node 200, and the lookup operation returns the outgoing flow ID. If no match is found, then a new flow channel may be allocated with a new outgoing flow ID, and the mapping between the incoming flow ID and the new outgoing flow ID may be added to the OFCT. EFCT function 206, IFCT function 208, and OFCT function 216 together form a flow-identifying logic responsible for identifying the flow to which an incoming packet belongs.

Output interface 218 is responsible for sending the outgoing packet to the next-hop node. The outgoing packet is now associated with the outgoing flow ID. In one example, the outgoing flow ID may replace the incoming flow ID in the packet header. When the packet arrives at the next-hop node, the flow ID in its header may be used to identify an input queue and to determine an entry in the IFCT of the next-hop node. The flow ID allows the next-hop node to identify an existing flow corresponding to the packet or allocate a new flow channel (i.e., provide a new input queue and add a new entry in the IFCT) for the packet. A similar process may be performed on each intermediate node until the packet exits the fabric.

A network node may have more or fewer components than those shown in FIG. 2. For example, it may include a congestion-management logic unit that performs flow-channel-based congestion management on received packets based on congestion information included in the IFCT. The congestion information may be reported by the ACK packets sent from the egress edge switch. In addition, the network node may also include an ACK crossbar switch for forwarding the ACK packets in the upstream direction.

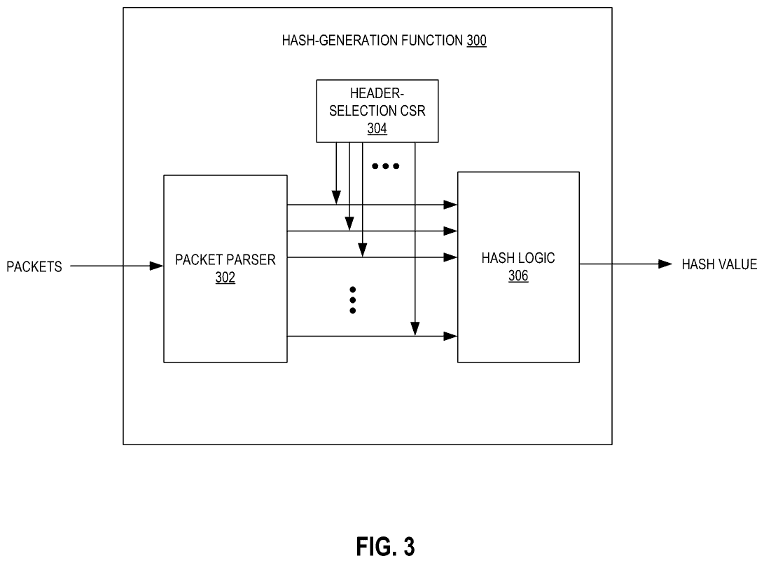

FIG. 3 illustrates the block diagram of an example hash-generation function, according to one aspect of the instant application. In FIG. 3, hash-generation function 300 includes a packet parser 302, a header-selection CSR 304, and a hash logic 306. Hash-generation function 300 may be part of an edge node (e.g., an edge switch) of a switch fabric. The various components in hash-generation function 300 may be implemented using any form of hardware, firmware, software, or a combination thereof.

Packet parser 302 is responsible for parsing an incoming packet to extract the various header fields included in the packet. In one example, packet parser 302 may extract layer-2 (L2) headers, layer-3 (L3) headers, layer-4 (L4) headers, encapsulation headers, etc. Examples of the extracted header fields include but are not limited to the IP address fields (e.g., source/destination address), the User Datagram Protocol (UDP) port fields (e.g., source/destination port), the traffic-class field, the DSCP field, the flow-label field, the VNI field, the UEC entropy fields, the snoop-number field, etc.

Header-selection CSR 304 is responsible for selecting a subset of headers from the headers extracted by packet parser 302 to be included in the hash calculation. According to some aspects, header-selection CSR 304 may include a plurality of bits corresponding to the header fields extracted from the packet. In one example, a bit “1” may indicate that the corresponding header field is included in the hash calculation, whereas a bit “0” may indicate that the corresponding header field is excluded from the hash calculation. A network administrator may configure hash-generation function 300 by writing to header-selection CSR 304 (e.g., setting a number of predetermined bits to “1”). In one example, header fields included in the hash calculation may contain the source and destination IP address fields, the source port field, the traffic class field, and the snoop-number field. Including the snoop number in the hash calculation can provide the separation between the snooped packets going to different destinations. In situations where the packets are tunneled through overlay networks (e.g., using VXLAN), the selected headers may also include encapsulation headers (e.g., the VNI field) and the layered headers inside the encapsulation, which may include but are not limited to the L2 Ethernet header, the L3 IP header, and/or the L4 headers, such that the flows may be separated based on information from both the overlay and underlay networks. In this way the outer headers (which are used to direct the encapsulation) and the inner headers (which are taken from the packet inside the encapsulation) may both contribute to the flow separation against other packets heading to different destinations that are either directed by their outer or their inner headers.

Hash logic 306 is responsible for computing a hash value based on the selected header fields. Various hash algorithms may be implemented to calculate the hash value. The scope of this disclosure is not limited by the hash algorithm. The size of the input to hash logic 306 may vary, depending on the total length of the selected header fields. In some examples, the size of the output of hash logic may be fixed. In alternative examples, the size of the output of hash logic 306 may vary. The hash value generated by hash logic 306 should be sufficiently large to reduce the likelihood of a hash collision. According to some aspects, the hash value should be at least 40-bit long. As discussed previously, each hash value may be mapped to a locally unique flow ID to facilitate the separation of the flows. A flow ID typically has fewer bits than the hash value. In one example, each flow ID may be 12-bit long. According to some aspects, hash values are created without address translation, meaning that the separation of the incoming packets to different flow channels does not require header translation.

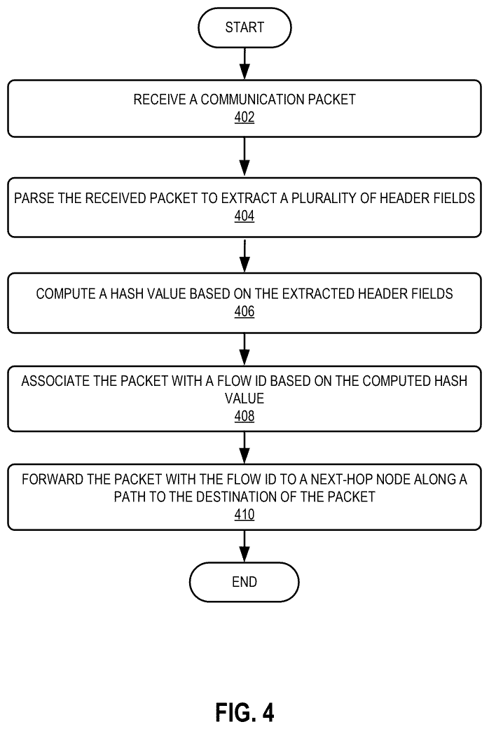

FIG. 4 presents a flowchart illustrating an example process for identifying packets belonging to different flow channels, according to one aspect of the instant application. All or any portion of the operations shown in FIG. 4 may be performed, for example, by a device or set of devices (e.g., edge node 106 or 116, network node 200, or hash-generation function 300 shown in FIG. 1, FIG. 2, and FIG. 3, respectively). Although the example process in FIG. 4 shows a specific order of performing certain operations, the process is not limited to such an order. Operations shown in succession in the flowchart may be performed in a different order and may be executed concurrently or with partial concurrence or combinations thereof.

During operation, a node in a fabric may receive a communication packet from a host (operation 402). The node may be one of a plurality edge nodes in a switch fabric (e.g., edge node 106 or 116 shown in FIG. 1). Depending on the implemented communication protocol, the packet may be a Transmission Control Protocol (TCP) packet, a UDP datagram, an IP packet, an Ethernet packet, etc.

A packet-parsing logic unit implemented on the node may parse the received packet to extract a plurality of header fields (operation 404). The packet-parsing logic unit may be similar to packet parser 302 shown in FIG. 3. The headers may include but are not limited to L2 headers, L3 headers, L4 headers, encapsulation headers, etc. According to some aspects, examples of the extracted header fields may include but are not limited to the IP address fields (e.g., source/destination address), the UDP port fields (e.g., source/destination port), the traffic-class field, the DSCP field, the flow-label field, the VNI field, the UEC entropy fields, the snoop-number field, etc. According to further aspects, a subset of the extracted header fields may be selected. For example, a CSR with a plurality of bits may be coupled to the outputs of the packet-parsing logic unit to select a subset of the extracted header fields.

A hash logic unit implemented on the node may compute a hash value based on the plurality of extracted header fields (operation 406). The hash logic unit may be similar to hash logic 306 shown in FIG. 3. According to some aspects, the hash logic unit may receive a subset of the header fields extracted by the packet-parsing logic unit and compute the hash value accordingly. The size of the input to the hash logic unit may vary, depending on the total length of the selected header fields. In some examples, the size of the output of the hash logic unit may be fixed. In alternative examples, the size of the output of the hash logic unit may vary. The hash value is sufficiently large to reduce the likelihood of a hash collision. According to some aspects, the hash value may be at least 40-bit long.

A flow-identifying logic unit implemented on the node may associate the packet with a flow ID based on the computed hash value (operation 408). More specifically, the flow-identifying logic unit may look up the EFCT maintained by the node using the hash value as the lookup key. The lookup may return a flow ID, indicating that the packet belongs to a previously established flow channel. If no matching entry is found in the EFCT, a new flow channel may be allocated for the packet, and the flow-identifying logic unit may associate the packet with a newly allocated flow ID. According to some aspects, the EFCT may be implemented using a match function (e.g., a TCAM, an exact match hash function implemented using multiple RAMs, or a match function implemented using a plurality of discrete logic gates). The node may also implement an IFCT that stores state information associated with the flow and an OFCT that stores a mapping between the incoming and outgoing flow IDs. Because the flow IDs are locally unique values, they typically have a shorter length than the hash value. According to some aspects, the flow IDs may have a fixed length. In one example, each flow ID may be 12-bit long.

The node may then forward the packet with the flow ID to the next-hop node along a path to the destination of the packet (operation 410). According to some aspects, when the packet leaves the node, the outgoing flow ID may be attached (e.g., as an additional header) to the packet. The attached flow ID allows the next-hop node to recognize that the packet belongs to a particular flow channel. For example, the next-hop node may look up its IFCT based on the flow ID to obtain state information (e.g., the congestion information) associated with the flow and then look up its OFCT to obtain the outgoing flow ID. Separating packets into different flow channels facilitates flow-channel-based congestion control. For example, the ingress switch of the fabric may throttle the injection of packets belonging to a congested flow channel.

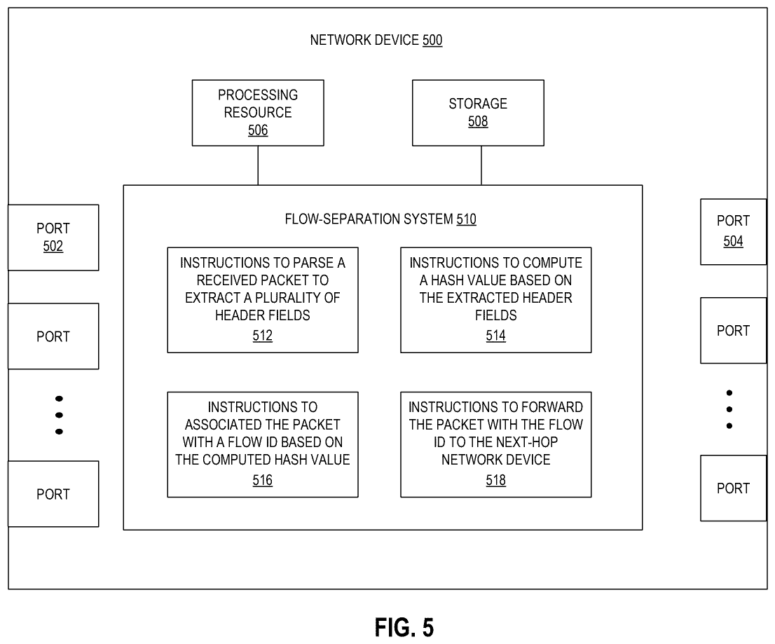

FIG. 5 illustrates an example block diagram of a network device, according to one aspect of the instant application. Network device 500 may include any physical devices that allow hardware on a computer network to communicate and interact with one another. Examples of network device 500 may include a switch, a router, a gateway, an access point, a network interface card (NIC), etc. In FIG. 5, network device 500 may include a number of communication ports, such as ports 502 and 504, for communicating with peer network devices.

Network device 500 may include one or more processing resources (e.g., processing resource 506), one or more storage devices (e.g., storage device 508), and a flow-separation system 510. Network device 500 may include fewer or more entities than those shown in FIG. 5.

In the examples described herein, a processing resource may include, for example, one processor or multiple processors included in a single computing device or distributed across multiple computing devices. As used herein, a “processor” may be at least one of a central processing unit (CPU), a semiconductor-based microprocessor, a graphics processing unit (GPU), a field-programmable gate array (FPGA) configured to retrieve and execute instructions, other electronic circuitry suitable for the retrieval and execution of instructions stored on a computer-readable storage medium, or a combination thereof. In the examples described herein, the processing resource may fetch, decode, and execute instructions stored on a storage medium to perform the functionalities described in relation to the instructions stored on the computer-readable medium. In other examples, the functionalities described in relation to any instructions described herein may be implemented in the form of electronic circuitry, in the form of executable instructions encoded on a computer-readable medium, or a combination thereof. The computer-readable storage medium may be located either in the computing device executing the instructions, or remote from but accessible to the computing device (e.g., via a computer network) for execution. In the examples illustrated herein, the node may be implemented by one computer-readable storage medium or multiple computer-readable storage media.

Flow-separation system 510 may include any number of software units, hardware units, and firmware units that work together to achieve the goal of separating incoming packets into different flow channels based on their header information. According to some aspects, flow-separation system 510 may include instructions, which when executed by processing resource 506 may cause processing resource 506 to perform methods and/or processes described in this disclosure. Specifically, flow-separation system 510 may include instructions 512 to parse a received packet to extract a plurality of header fields, as described above in relation to operation 404 shown in FIG. 4. According to some aspects, the plurality of extracted header fields may include but are not limited to the IP address fields (e.g., source/destination address), the UDP port fields (e.g., source/destination port), the traffic-class field, the DSCP field, the flow-label field, the VNI field, the UEC entropy fields, the snoop-number field, etc.

Flow-separation system 510 may include instructions 514 to compute a hash value based on the extracted header fields, as described above in relation to operation 406 shown in FIG. 4. According to some aspects, the hash value may be computed based on a subset of the extracted header fields. In some examples, the subset may include a source address field, a destination address field, and a traffic class field. In further examples, the subset may include an encapsulation header field (e.g., the VNI field), a DSCP field, a UDP source port field, one or more UEC transport headers, and a snoop number. The hash value may be sufficiently large (e.g., at least 40-bit long) to avoid hash collision.

Flow-separation system 510 may include instructions 516 to associate the packet with a flow ID based on the computed hash value, as described above in relation to operation 408 shown in FIG. 4. According to some aspects, instructions 516 may be used to lookup a flow-channel table storing the mappings between hash values and flow IDs, and the flow-channel table may be implemented using a match function (e.g., a TCAM). According to some aspects, instructions 516 may be used to attach the flow ID (e.g., as an additional header) to the packet.

Flow-separation system 510 may include instructions 518 to forward the packet with the flow ID to a next-hop network device, as described above in relation to operation 410 shown in FIG. 4. The attached flow ID allows the next-hop network device to recognize the packet as belonging to a flow channel corresponding to the flow ID. According to some aspects, the next-hop network device may look up its own flow-channel table to identify the flow channel.

Flow-separation system 510 may include more instructions than those shown in FIG. 5. For example, flow-separation system 510 may include instructions to write to a header-selection CSR to select a subset of header fields from the extracted header fields. In addition, flow-separation system 510 may include instructions to allocate a new flow ID in response to determining that an incoming packet does not belong to any existing flow channel.

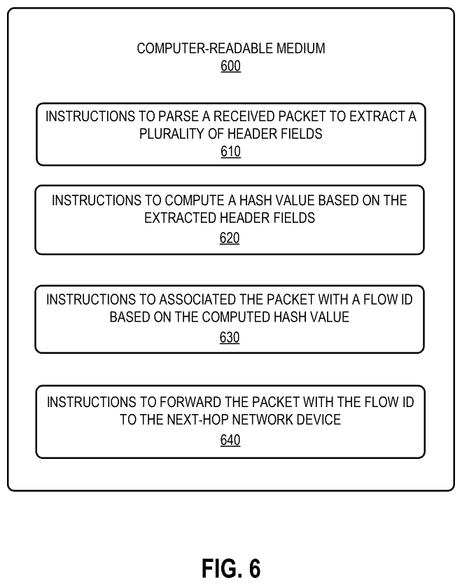

FIG. 6 illustrates a computer-readable medium that facilitates the separation of packet flows, according to one aspect of the instant application. CRM 600 may be a non-transitory computer-readable medium or device storing instructions that when executed by a computer or processing resource cause the computer or processing resource to perform a method. As used herein, a “computer-readable storage medium” may be any electronic, magnetic, optical, or other physical storage apparatus to contain or store information such as executable instructions, data, and the like. For example, any computer-readable storage medium described herein may be any of RAM, EEPROM, volatile memory, non-volatile memory, flash memory, a storage drive (e.g., an HDD, an SSD), any type of storage disc (e.g., a compact disc, a DVD, etc.), or the like, or a combination thereof. Further, any computer-readable storage medium described herein may be non-transitory.

CRM 600 may store instructions 610 to parse a received packet to extract a plurality of header fields, as described above in relation to operation 404 shown in FIG. 4; instructions 620 to compute a hash value based on the extracted header fields, as described above in relation to operation 406 shown in FIG. 4; instructions 630 to associate the packet with a flow ID based on the computed hash value, as described above in relation to operation 408 shown in FIG. 4; and instructions 640 to forward the packet with the flow ID to a next-hop network device, as described above in relation to operation 410 shown in FIG. 4.

CRM 600 may include more instructions than those shown in FIG. 6. For example, CRM 600 may include instructions to write to a header-selection CSR to select a subset of header fields from the extracted header fields. In addition, CRM 600 may include instructions to allocate a new flow ID in response to determining that an incoming packet does not belong to any existing flow channel.

In general, aspects of the disclosure solve the technical problem of separating packets into different flows that may extend across multiple independently managed fabrics. An ingress edge node of a fabric may be configured to compute a single hash value based on a plurality of header fields of an incoming packet without the need to perform header translation. Examples of the headers used for the hash computation may include but are not limited to: the IP address fields (e.g., source/destination address), the UDP port fields (e.g., source/destination port), the traffic-class field, the DSCP field, the flow-label field, the VNI field, the UEC entropy fields, the snoop-number field, etc. This single hash value may be sufficiently large (e.g., 40 bits or longer) to reduce the likelihood of a hash collision. The ingress edge node may maintain a hash-to-flow ID mapping table that maps hash values to flow IDs, thus allowing incoming packets with different destinations to be separated into different flows. Separating incoming packets into different flows facilitates flow-channel-based congestion control.

One aspect of the instant application provides a network node. The network node may include a packet-header parser to extract a plurality of header fields from a received packet, a hash logic unit to compute a hash value based on the plurality of extracted header fields, and a flow-identifying logic unit to associate the packet with a flow identifier (ID) based on the computed hash value. The flow ID facilitates subsequent network nodes along a path to the packet's destination to recognize the packet as belonging to a flow.

In a variation on this aspect, in response to determining that the packet belongs to an existing flow, the flow-identifying logic unit is to associate the packet with the flow ID corresponding to the existing flow. In response to determining that the packet belongs to a new flow, the flow-identifying logic unit is to allocate the new flow and associate the packet with the flow ID corresponding to the new flow.

In a variation on this aspect, the flow-identifying logic unit may include a match function to perform a match operation based on the computed hash value, and the match function is implemented using a Ternary Content Addressable Memory (TCAM), a plurality of Random-Access Memories (RAMs), or a plurality of discrete logic gates.

In a variation on this aspect, the network node may further include a control and status register (CSR) to select, from the plurality of header fields, a subset of header fields for computation of the hash value. The subset of header fields may include at least a source address field, a destination address field, and a traffic class field.

In a further variation, the subset of header fields may further include one or more of: an encapsulation header field, a Differentiated Service Code Point (DSCP) field, a User Datagram Protocol (UDP) port field, one or more Ultra Ethernet Consortium (UEC) Transport headers, or a snoop number field.

In a further variation, the packet is encapsulated, and wherein the subset of header fields further comprise layered header fields within the encapsulation.

In a variation on this aspect, the network node may further include a congestion-management logic unit to perform flow-channel-based congestion management on received packets.

In a variation on this aspect, the hash value may include a first number of bits, the flow ID may include a second number of bits, and the second number is smaller than the first number.

In a variation on this aspect, the flow-identifying logic unit is to associate the packet with the flow ID without performing header translation.

One aspect of the instant application provides a system and method for separating packets into flows. During operation, the system may extract, at a network device, a plurality of header fields from a received packet; compute a hash value based on the plurality of extracted header fields; and associate the packet with a flow identifier (ID) based on the computed hash value. The flow ID facilitates subsequent network devices along a path to the packet's destination to recognize the packet as belonging to a flow.

One aspect of the instant application provides a non-transitory machine-readable storage medium storing instructions executable by a processing resource to: extract a plurality of header fields from a packet received at a network device, compute a hash value based on the plurality of extracted header fields, and associate the packet with a flow identifier (ID) based on the computed hash value. The flow ID facilitates subsequent network devices along a path to the packet's destination to recognize the packet as belonging to a flow.

In this disclosure, the functions and subfunctions shown in FIGS. 2 and 3 may be implemented using any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits or sub-functions described herein might be implemented as discrete circuits or the functions and features described can be shared in part or in total among one or more circuits. Even though various features or elements of functionality may be individually described or claimed as separate functions, these features and functionality can be shared among one or more common functions, and such description shall not require or imply that separate functions are required to implement such features or functionality.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

The methods and processes described above can be included in hardware modules or apparatus. The hardware modules or apparatus can include, but are not limited to, application-specific integrated circuit (ASIC) chips, field-programmable gate arrays (FPGAs), dedicated or shared processors that execute a particular software module or a piece of code at a particular time, and other programmable-logic devices now known or later developed. When the hardware modules or apparatus are activated, they perform the methods and processes included within them.

The foregoing description is presented to enable any person skilled in the art to make and use the aspects and examples and is provided in the context of a particular application and its requirements. Various modifications to the disclosed aspects will be readily apparent to those skilled in the art, and the general principles defined herein may be applied to other aspects and applications without departing from the spirit and scope of the present disclosure. Thus, the aspects described herein are not limited to the aspects shown but are to be accorded the widest scope consistent with the principles and features disclosed herein.

Furthermore, the foregoing descriptions of aspects have been presented for purposes of illustration and description only. They are not intended to be exhaustive or to limit the aspects described herein to the forms disclosed. Accordingly, many modifications and variations will be apparent to practitioners skilled in the art. Additionally, the above disclosure is not intended to limit the aspects described herein. The scope of the aspects described herein is defined by the appended claims.

What is claimed is:

1. A network node, comprising:
a packet-header parser to extract a plurality of header fields from a received packet;
a hash logic unit to compute a hash value based on the plurality of extracted header fields; and
a flow-identifying logic unit to associate the packet with a flow identifier (ID) based on the computed hash value, the flow ID facilitating subsequent network nodes along a path to the packet's destination to recognize the packet as belonging to a flow.

2. The network node of claim 1, wherein the flow-identifying logic unit is to:
in response to determining that the packet belongs to an existing flow, associate the packet with the flow ID corresponding to the existing flow; and
in response to determining that the packet belongs to a new flow, allocate the new flow and associate the packet with the flow ID corresponding to the new flow.

3. The network node of claim 1, wherein the flow-identifying logic unit comprises a match function to perform a match operation based on the computed hash value, and wherein the match function is implemented using a Ternary Content Addressable Memory (TCAM), a plurality of Random-Access Memories (RAMs), or a plurality of discrete logic gates.

4. The network node of claim 1, further comprising a control and status register (CSR) to select, from the plurality of header fields, a subset of header fields for computation of the hash value, wherein the subset of header fields comprises at least a source address field, a destination address field, and a traffic class field.

5. The network node of claim 4, wherein the subset of header fields further comprises one or more of:
an encapsulation header field;
a Differentiated Service Code Point (DSCP) field;
a User Datagram Protocol (UDP) port field;
one or more Ultra Ethernet Consortium (UEC) Transport headers; or
a snoop number field.

6. The network node of claim 4, wherein the packet is encapsulated, and wherein the subset of header fields further comprise layered header fields within the encapsulation.

7. The network node of claim 1, further comprising a congestion-management logic unit to perform flow-channel-based congestion management on received packets.

8. The network node of claim 1, wherein the hash value comprises a first number of bits, and wherein the flow ID comprises a second number of bits, the second number being smaller than the first number.

9. The network node of claim 1, wherein the flow-identifying logic unit is to associate the packet with the flow ID without performing header translation.

10. A method, comprising:
extracting, at a network device, a plurality of header fields from a received packet;
computing a hash value based on the plurality of extracted header fields; and
associating the packet with a flow identifier (ID) based on the computed hash value, the flow ID facilitating subsequent network devices along a path to the packet's destination to recognize the packet as belonging to a flow.

11. The method of claim 10, comprising:
in response to determining that the packet belongs to an existing flow, associating the packet with the flow ID corresponding to the existing flow; and
in response to determining that the packet belongs to a new flow, allocating the new flow and associating the packet with the flow ID corresponding to the new flow.

12. The method of claim 10, wherein associating the packet with the flow ID comprises performing a match operation based on the computed hash value, wherein the perform the match operation comprising looking up a table stored in a Ternary Content Addressable Memory (TCAM), a plurality of Random-Access Memories (RAMs), or a plurality of discrete logic gates.

13. The method of claim 10, further comprising selecting, from the plurality of header fields, a subset of header fields for computation of the hash value, wherein the subset of header fields comprises at least a source address field, a destination address field, and a traffic class field.

14. The method of claim 13, wherein the subset of header fields further comprises one or more of:
an encapsulation header field;
a Differentiated Service Code Point (DSCP) field;
a User Datagram Protocol (UDP) port field;
one or more Ultra Ethernet Consortium (UEC) Transport headers; or
a snoop number field.

15. The method of claim 13, wherein the packet is encapsulated, and wherein the subset of header fields further comprise layered header fields within the encapsulation.

16. The method of claim 10, further comprising performing flow-channel-based congestion management on received packets.

17. The method of claim 10, wherein the hash value comprises a first number of bits, and wherein the flow ID comprises a second number of bits, the second number being smaller than the first number.

18. The method of claim 10, wherein associating the packet with the flow ID does not involve header translation.

19. A non-transitory machine-readable storage medium storing instructions executable by a processing resource to:
extract a plurality of header fields from a packet received at a network device;
compute a hash value based on the plurality of extracted header fields; and
associate the packet with a flow identifier (ID) based on the computed hash value, the flow ID facilitating subsequent network devices along a path to the packet's destination to recognize the packet as belonging to a flow.

20. The non-transitory machine-readable storage medium of claim 19, wherein the header fields comprise one or more of:
a source address field;
a destination address field;
a traffic class field;
an encapsulation header field;
a Differentiated Service Code Point (DSCP) field;
a User Datagram Protocol (UDP) port field;
one or more Ultra Ethernet Consortium (UEC) Transport headers; or
a snoop number field.
